(19) United States
(12) Patent Application Publication
(10) Pub. No.: US 2026/0270114 A1
(43) Pub. Date: Sep. 10, 2026

(54) WIRELESS COMMUNICATION METHOD, APPARATUS, AND DEVICE

(71) Applicant: RUIJIE NETWORKS CO., LTD., Fuzhou (CN)

(72) Inventor: Ke ZHONG, Fuzhou (CN)

(21) Appl. No.: 19/663,293

(22) Filed: Apr. 30, 2026

Related U.S. Application Data
(63) Continuation of application No. PCT/CN2025/100516, filed on Jun. 11, 2025.

(30) Foreign Application Priority Data
Jun. 13, 2024 (CN) 202410764098.1

(51) Int. Cl. H04L 25/02; H04L 5/00

(52) U.S. Cl. CPC H04L 25/0204; H04L 5/0094

(57) ABSTRACT

A wireless communication method, an apparatus, and a device are provided. The method includes: indicating, by an access point device, an ultra high reliability long training field UHR-LTF configuration to a station device; and receiving, by the access point device, a physical layer protocol data unit PPDU on a target resource unit, where the PPDU includes a UHR-LTF, the UHR-LTF is generated based on the UHR-LTF configuration, and the target resource unit includes a distributed tone resource unit DRU and/or a contiguous resource unit.

### CROSS-REFERENCE TO RELATED APPLICATIONS

This application is a continuation of International Application No. PCT/CN2025/100516, filed on Jun. 11, 2025, which claims priority to Chinese Patent Application No. 202410764098.1, filed with the China National Intellectual Property Administration on Jun. 13, 2024 and entitled “WIRELESS COMMUNICATION METHOD, APPARATUS, AND DEVICE”, both of which are incorporated herein by reference in their entireties.

### TECHNICAL FIELD

This application relates to the communication field, and in particular, to a wireless communication method, an apparatus, and a device.

### BACKGROUND

In the related art, a station device may transmit a physical layer protocol data unit (PPDU) using a regular resource unit (RRU), where the PPDU includes a long training field (LTF) for channel estimation.

In some scenarios, to overcome power spectral density limits to achieve extended coverage and enhanced range versus rate (RvR), a distributed tone resource unit (DRU) is introduced. The main idea of the DRU is to allocate tones of a small-size resource unit (RU) to a large bandwidth, making the tones of each field non-contiguous. As a result, each tone may be transmitted at higher power.

Therefore, how to transmit an LTF to ensure channel estimation performance during PPDU transmission on a DRU is an urgent problem to be solved.

### SUMMARY

This application provides a wireless communication method, an apparatus, and a device, so as to transmit an LTF to ensure channel estimation performance during PPDU transmission on a DRU.

According to a first aspect, a wireless communication method is provided, including:
indicating, by an access point device, an ultra high reliability long training field UHR-LTF configuration to a station device; and
receiving, by the access point device, a physical layer protocol data unit PPDU on a target resource unit, where the PPDU includes a UHR-LTF, the UHR-LTF is generated based on the UHR-LTF configuration, and the target resource unit includes a distributed tone resource unit DRU and/or a contiguous resource unit.

In a possible implementation, for a UHR-LTF, corresponding to a distributed bandwidth of the DRU, in the PPDU, a sequence used by the UHR-LTF is related to a bandwidth of the PPDU.

In a possible implementation, for a UHR-LTF, corresponding to a distributed bandwidth of the DRU, in the PPDU, a quantity of tones occupied by the UHR-LTF is the same as a quantity of tones occupied by a largest contiguous resource unit corresponding to a distributed bandwidth of the PPDU.

In a possible implementation, for a UHR-LTF, corresponding to a distributed bandwidth of the DRU, in the PPDU, for different spatial stream quantities, an initial number of symbols of the UHR-LTF is the same as an initial number of symbols of an EHT-LTF, or the initial number of symbols of the UHR-LTF comprises the initial number of symbols of the EHT-LTF and an additional initial number of symbols.

In a possible implementation, a number of symbols of the UHR-LTF is greater than or equal to a maximum value of an initial number of symbols of a UHR-LTF on each DRU or multiple distributed tone resource unit MDRU.

In a possible implementation, a maximum value of the initial number of symbols of the UHR-LTF is 16, or the maximum value of the initial number of symbols of the UHR-LTF is selected from a set {2, 4, 8, 10, 12, 14, 16}.

In a possible implementation, the PPDU supports at least the following three guard interval types: 0.8 us, 1.6 us, and 3.2 us.

In a possible implementation, the PPDU further supports at least one of the following guard interval types: 0.1 us, 0.2 us, 0.4 us, 6.4 us, 12.8 us, or 25.6 us.

In a possible implementation, when a preamble of the PPDU is transmitted in a puncturing manner, a single large-size MDRU used for transmitting the preamble spans a non-punctured portion of a PPDU bandwidth, wherein the large-size MDRU is a combination of a plurality of large-size DRUs, a quantity of tones occupied by the large-size DRU is greater than or equal to a preset value, and the preamble comprises the UHR-LTF.

In a possible implementation, sequence values of the UHR-LTF on tones outside the large-size MDRU are set to 0.

In a possible implementation, the UHR-LTF is transmitted by the station device using a local CSD or a global CSD.

In a possible implementation, the UHR-LTF is transmitted by the station device using a local CSD or a global CSD on each distributed bandwidth within a PPDU bandwidth.

In a possible implementation, the local CSD or the global CSD is allocated based on a first table or a first value set, wherein the first table is a correspondence table between total spatial stream quantities and cyclic shift values, the first value set comprises a plurality of candidate cyclic shift values, the plurality of candidate cyclic shift values correspond to a plurality of total spatial stream quantities, and a maximum value of the total spatial stream quantity is 8.

In a possible implementation, the local CSD or the global CSD is allocated based on a second table or a second value set, wherein the second table is a correspondence table between total spatial stream quantities and cyclic shift values, the second value set comprises a plurality of candidate cyclic shift values, the plurality of candidate cyclic shift values correspond to a plurality of total spatial stream quantities, and a maximum value of the total spatial stream quantity is greater than 8.

In a possible implementation, the maximum value of the total spatial stream quantity is 12 or 16.

According to a second aspect, a wireless communication method is provided, including:
receiving, by a station device, an ultra high reliability long training field UHR-LTF configuration from an access point device; and
transmitting, by the station device, a physical layer protocol data unit PPDU on a target resource unit, where the PPDU includes a UHR-LTF, the UHR-LTF is generated based on the UHR-LTF configuration, and the target resource unit includes a distributed tone resource unit DRU and/or a contiguous resource unit.

In a possible implementation, for a UHR-LTF corresponding to a distributed bandwidth of the DRU in the PPDU, a sequence used by the UHR-LTF is related to a bandwidth of the PPDU.

In a possible implementation, for a UHR-LTF corresponding to a distributed bandwidth of the DRU in the PPDU, a quantity of tones occupied by the UHR-LTF is the same as a quantity of tones occupied by a largest contiguous resource unit corresponding to a distributed bandwidth of the PPDU.

In a possible implementation, for a UHR-LTF corresponding to a distributed bandwidth of the DRU in the PPDU, for different spatial stream quantities, an initial number of symbols of the UHR-LTF is the same as an initial number of symbols of an EHT-LTF, or the initial number of symbols of the UHR-LTF comprises the initial number of symbols of the EHT-LTF and an additional initial number of symbols.

In a possible implementation, a number of symbols of the UHR-LTF is greater than or equal to a maximum value of an initial number of symbols of a UHR-LTF on each DRU or multiple distributed tone resource unit MDRU.

In a possible implementation, a maximum value of the initial number of symbols of the UHR-LTF is 16, or the maximum value of the initial number of symbols of the UHR-LTF is selected from a set {2, 4, 8, 10, 12, 14, 16}.

In a possible implementation, the PPDU supports at least the following three guard interval types: 0.8 us, 1.6 us, and 3.2 us.

In a possible implementation, the PPDU further supports at least one of the following guard interval types: 0.1 us, 0.2 us, 0.4 us, 6.4 us, 12.8 us, or 25.6 us.

In a possible implementation, when a preamble of the PPDU is transmitted in a puncturing manner, a single large-size MDRU used for transmitting the preamble spans a non-punctured portion of a PPDU bandwidth, wherein the large-size MDRU is a combination of a plurality of large-size DRUs, a quantity of tones occupied by the large-size DRU is greater than or equal to a preset value, and the preamble comprises the UHR-LTF.

In a possible implementation, sequence values of the UHR-LTF on tones outside the large-size MDRU are set to 0.

In a possible implementation, the UHR-LTF is transmitted by the station device using a local CSD or a global CSD.

In a possible implementation, the UHR-LTF is transmitted by the station device using a local CSD or a global CSD on each distributed bandwidth within a PPDU bandwidth.

In a possible implementation, the local CSD or the global CSD is allocated based on a first table or a first value set, wherein the first table is a correspondence table between total spatial stream quantities and cyclic shift values, the first value set comprises a plurality of candidate cyclic shift values, the plurality of candidate cyclic shift values correspond to a plurality of total spatial stream quantities, and a maximum value of the total spatial stream quantity is 8.

In a possible implementation, the local CSD or the global CSD is allocated based on a second table or a second value set, wherein the second table is a correspondence table between total spatial stream quantities and cyclic shift values, the second value set comprises a plurality of candidate cyclic shift values, the plurality of candidate cyclic shift values correspond to a plurality of total spatial stream quantities, and a maximum value of the total spatial stream quantity is greater than 8.

In a possible implementation, the maximum value of the total spatial stream quantity is 12 or 16.

According to a third aspect, a wireless communication apparatus is provided, including:
a transmitting module, configured to indicate an ultra high reliability long training field UHR-LTF configuration to a station device; and
a receiving module, configured to receive a physical layer protocol data unit PPDU on a target resource unit, where the PPDU includes a UHR-LTF, the UHR-LTF is generated based on the UHR-LTF configuration, and the target resource unit includes a distributed tone resource unit DRU and/or a contiguous resource unit.

According to a fourth aspect, a wireless communication apparatus is provided, including:
a receiving module, configured to receive an ultra high reliability long training field UHR-LTF configuration from an access point device; and
a transmitting module, configured to transmit a physical layer protocol data unit PPDU on a target resource unit, where the PPDU includes a UHR-LTF, the UHR-LTF is generated based on the UHR-LTF configuration, and the target resource unit includes a distributed tone resource unit DRU and/or a contiguous resource unit.

According to a fifth aspect, an access point device is provided, including a processor and a memory. The memory is configured to store a computer program, and the processor is configured to invoke and run the computer program stored in the memory to execute the method according to the first aspect or any implementation thereof.

According to a sixth aspect, a station device is provided, including a processor and a memory. The memory is configured to store a computer program, and the processor is configured to invoke and run the computer program stored in the memory to execute the method according to the second aspect or any implementation thereof.

According to a seventh aspect, a chip is provided, configured to implement the method according to the first aspect or the second aspect or any implementation thereof. Specifically, the chip includes a processor configured to invoke and run a computer program from a memory, so that a device installed with the chip executes the method according to the first aspect or the second aspect or any implementation thereof.

According to an eighth aspect, a readable storage medium is provided, configured to store a computer program. The computer program causes a computer to execute the method according to the first aspect or the second aspect or any implementation thereof.

According to a ninth aspect, a computer program product is provided, including computer program instructions. The computer program instructions cause a computer to execute the method according to the first aspect or the second aspect or any implementation thereof.

According to a tenth aspect, a computer program is provided. When the computer program is run on a computer, the computer is caused to execute the method according to the first aspect or the second aspect or any implementation thereof.

In the foregoing technical solution, the access point device may indicate the UHR-LTF configuration for transmitting the PPDU on the DRU to the station device, so that the station device may fill the UHR-LTF in the PPDU based on the UHR-LTF configuration, implementing transmission of the UHR-LTF while ensuring channel estimation performance during PPDU transmission on the DRU.

### BRIEF DESCRIPTION OF DRAWINGS

FIG. 1 is a schematic diagram of a communication system applicable to embodiments of this application.

FIG. 2 is a schematic diagram of a format of an EHT TB PPDU.

FIG. 3 is a schematic diagram of a wireless communication method according to an embodiment of this application.

FIG. 4 is a schematic diagram of PPDU transmission according to an embodiment of this application.

FIG. 5 is a schematic diagram of RU allocation under 20 MHz.

FIG. 6 is a schematic diagram of another PPDU transmission according to an embodiment of this application.

FIG. 7 is a schematic diagram of RU allocation under 80 MHz.

FIG. 8 is a schematic block diagram of a wireless communication apparatus according to an embodiment of this application.

FIG. 9 is a schematic block diagram of a wireless communication apparatus according to an embodiment of this application.

FIG. 10 is a schematic block diagram of a communication device according to an embodiment of this application.

FIG. 11 is a schematic block diagram of a chip according to an embodiment of this application.

FIG. 12 is a schematic block diagram of a communication system according to an embodiment of this application.

### DESCRIPTION OF EMBODIMENTS

The following describes the technical solutions in the embodiments of this application with reference to the accompanying drawings in the embodiments of this application. Apparently, the described embodiments are only some but not all of the embodiments of this application. All other embodiments obtained by persons of ordinary skill in the art based on the embodiments of this application without creative efforts shall fall within the protection scope of this application.

It should be noted that in this specification, the terms “include”, “comprise”, or any other variants thereof are intended to cover a non-exclusive inclusion, such that a process, method, article, or apparatus that includes a series of elements includes not only those elements but also other elements that are not expressly listed, or further includes elements inherent to such process, method, article, or apparatus. In addition, the terms “first”, “second”, and so on in this specification are used only to distinguish between different objects but do not indicate a particular order.

It should be noted that in the embodiments of this application, “at least one” means one or more, “a plurality of” means two or more, and “at least two” means two or more. “At least one of the following” or similar expressions may represent any combination thereof. For example, at least one of a, b, or c may mean a, b, c, “a and b”, “a and c”, “b and c”, or “a, b, and c”.

It should be noted that in the embodiments of this application, “and/or” indicates that three relationships of the connected objects may exist, for example, “A and/or B” indicates the following three cases: only A, only B, or both A and B. The character “/” generally indicates an “or” relationship between the contextually associated objects.

It should be understood that “indicate” mentioned in the embodiments of this application may be a direct indication or an indirect indication. For example, A indicates B, which may mean that A directly indicates B, for example, B may be obtained from A; or may mean that A indirectly indicates B, for example, A indicates C, and B may be obtained from C, for example, B and C have an association relationship.

The technical solution provided in the embodiments of this application may be applied to a wireless local area network (WLAN) system, such as a Wi-Fi protocol. The Wi-Fi protocol may include but is not limited to 802.11 series of protocols, such as 802.11a protocol, 802.11ax protocol, 802.11ac protocol, 802.11b protocol, 802.11be protocol, 802.11g protocol, 802.11n protocol, 802.11bn protocol, or a next-generation protocol. Alternatively, the technical solution may be applied to a wireless personal area network system based on ultra wide band (UWB), a sensing (sensing) system, or the like.

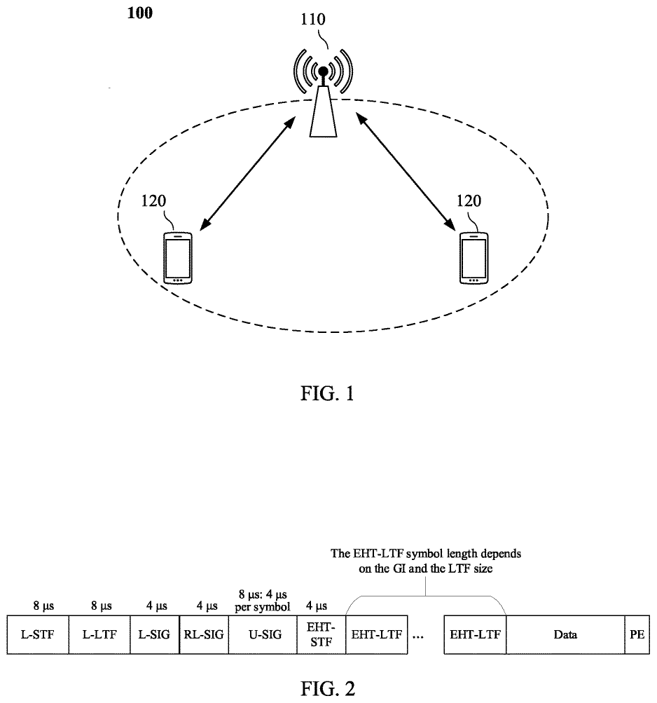

FIG. 1 is a schematic structural diagram of a communication system 100 applicable to embodiments of this application. The communication system 100 may include an access point (AP) 110 and a station (STA) 120. The station 120 may access the network via the access point 110.

The access point may support communication or sensing based on a Wi-Fi protocol, such as 802.11a protocol, 802.11ax protocol, 802.11ac protocol, 802.11b protocol, 802.11be protocol, 802.11g protocol, 802.11n protocol, 802.11bn protocol, or a next-generation protocol.

The station may support communication or sensing based on a Wi-Fi protocol, such as 802.11a protocol, 802.11ax protocol, 802.11ac protocol, 802.11b protocol, 802.11be protocol, 802.11g protocol, 802.11n protocol, 802.11bn protocol, or a next-generation protocol.

The communication in the communication system 100 may be communication between an access point and a station, between a station and a station, or between an access point and an access point.

The access point acts as a bridge connecting a wired network and a wireless network, and its main function is to connect various wireless network clients together and then access the Ethernet via the wireless network.

The station is also referred to as a non-access point station (non-AP STA), and the access point is also referred to as an access point station (AP STA), that is, the access point is also a type of station in a sense.

In some scenarios, the access point and station may be devices applied in the internet of vehicles, nodes or sensors in the internet of things (IoT), smart cameras, smart remote controls, or smart water and electricity meters in smart home, sensors in smart city, or the like.

In some scenarios, the access point may be a terminal device (such as a mobile phone) with a Wi-Fi chip or a network device (such as a router).

In the embodiments of this application, the station may be a mobile phone, a tablet computer, a computer, a virtual reality (VR) device, an augmented reality (AR) device, a wireless device in industrial control, a set-top box, a wireless device in self driving, an in-vehicle communication device, a wireless device in remote medical treatment, a wireless device in smart grid, a wireless device in transportation safety, a wireless device in smart city, a wireless device in smart home, a wireless communication chip, or the like, supporting WLAN or Wi-Fi technologies.

It should be understood that FIG. 1 shows only one access point and two stations. Optionally, the communication system 100 may include a plurality of access points or another quantity of stations, which is not limited in the embodiments of this application.

Optionally, the communication system 100 may further include other devices, such as a network controller, a gateway, or other network entities, which are not limited in this application.

For ease of understanding of the embodiments of this application, a distributed tone resource unit (DRU) related to this application is described.

In the embodiments of this application, a tone is also referred to as a frequency tone.

The DRU is a current research hotspot in the Wi-Fi 8 physical layer. The DRU may overcome power spectral density (PSD) limits (for example, the PSD limit for a non-AP STA under 6 GHz low probability of intercept (LPI) is −1 dBm/MHz) to achieve extended coverage and enhanced range versus rate (RvR).

The main idea of the DRU is to allocate tones of a small-size resource unit (RU) to a large bandwidth, making the tones of each STA non-contiguous. As a result, each tone may be transmitted at higher power due to the lower subcarrier density of the STA under the PSD limit of −1 dBm/MHz.

In some scenarios, an RU with contiguous tones is defined and called a regular resource unit (RRU).

If the tones of the DRU are well planned, the maximum transmit power of one DRU may be calculated using the following formula (1):

$$P = 10 lg ( {N}_{RU} \frac{{10}^{- 0.1}}{M} ) \qquad Formula ( 1 )$$

N_{RU} represents an RU size, such as 26, 52, or 106.

M represents a quantity of tones occupied by the DRU in every 13 subcarriers. For example, if a subcarrier spacing is 78.125 kHz, a 1 MHz bandwidth has 12.8 subcarriers, approximately equal to 13 subcarriers.

10^{-0.1} represents transmit power (mW) of −1 dBm in a 1 MHz bandwidth.

N_{RU}/M*13 should be less than N_{DBW}, where N_{DBW} represents a quantity of subcarriers in the corresponding distributed bandwidth (DBW).

In some scenarios, M may be calculated using the following formula (2):

$$M = ⌈ 13 \cdot \frac{{N}_{RU}}{{N}_{DBW}} ⌉ \qquad Formula ( 2 )$$

It can be learned from comparison between formula (1) and formula (2) that the maximum transmit power of the DRU is a function of the DRU size (that is, N_{RU}) and the DBW of the DRU.

Table A shows values of the maximum transmit power of the RRU and the DRU under different N_{RU} and DBW conditions.

TABLE A

| | | DRU | | | |
|---|---|---|---|---|---|
| | | DBW = 20 MHz | DBW = 40 MHz | DBW = 80 MHz | DBW = 160 MHz |
| N_{RU} | RRU | (N_{DBW} = 256) | (N_{DBW} = 512) | (N_{DBW} = 1024) | (N_{DBW} = 2048) |
| 26 | 2.08 | 10.14 (M = 2) | 13.15 (M = 1) | 13.15 (M = 1) | 13.15 (M = 1) |
| 52 | 5.09 | 11.39 (M = 3) | 13.15 (M = 2) | 16.16 (M = 1) | 16.16 (M = 1) |
| 106 | 8.18 | 11.47 (M = 6) | 14.48 (M = 3) | 16.24 (M = 2) | 19.25 (M = 1) |
| 262 | 11.77 | N/A | 14.39 (M = 7) | 16.82 (M = 4) | 19.83 (M = 2) |
| 484 | 14.78 | N/A | N/A | 17.40 (M = 7) | 19.83 (M = 4) |
| 996 | 17.91 | N/A | N/A | N/A | 20.53 (M = 7) |

The maximum transmit power of the RRU may be calculated using 10*lg(N_{RU}*0.078125)−1 (dBm).

Table B shows transmit power gains of the DRU compared to RRU within different distributed bandwidths. It can be learned that the gain is related to the RU size (that is, N_{RU}) and the distributed bandwidth.

TABLE B

| | DRU | | | |
|---|---|---|---|---|
| | DBW = 20 MHz | DBW = 40 MHz | DBW = 80 MHz | DBW = 160 MHz |
| N_{RU} | (N_{DBW} = 256) | (N_{DBW} = 512) | (N_{DBW} = 1024) | (N_{DBW} = 2048) |
| 26 | 8.06 | 11.07 | 11.07 | 11.07 |
| 52 | 6.3 | 8.06 | 11.07 | 11.07 |
| 106 | 3.29 | 6.3 | 8.06 | 11.07 |
| 262 | N/A | 2.62 | 5.05 | 8.06 |
| 484 | N/A | N/A | 2.62 | 5.05 |
| 996 | N/A | N/A | N/A | 2.62 |

It can be learned from Table B that small and large distributed bandwidths both correspond to corresponding transmit power gains.

A STA may transmit a DRU at higher power compared to transmitting an RRU. For example, for a 52-tone DRU in an 80 MHz bandwidth, there may be only one tone per MHz bandwidth, while for a 52-tone RRU, there are approximately 13 tones per MHz. In this case, under the PSD limit of −1 dBm/MHz in the 6 GHz LPI frequency band, for a 52-tone RU, using the DRU may increase the transmit power of 11 dB (10*log 10(12.8)=11.07 dB). For another example, for 80 MHz uplink OFDMA transmission with eight users, each user using a 106-tone DRU, compared to each user using a 106-tone RRU, may improve the overall performance by 8.06 dB.

The increase in the transmit power may enable a higher modulation and coding scheme (MCS) or achieve a farther distance range.

Some design criteria for the DRU are as follows.

1. Maximize the transmit power of each tone by minimizing the quantity of tones per MHz (that is, increasing the interval of tones in one RU).

2. Distribute the tones in one DRU as evenly as possible to achieve simplification and balance in smoothing (smoothing), phase (phase), and implementation.

The DRU plays an important role in uplink orthogonal frequency division multiple access (OFDMA). For example, a plurality of STAs may all use the DRU to increase the transmit power. For different STAs, different tones may be used, that is, for different STAs, the DRU is composed of different tones. As compared to using RRUs of the same size, all tones may obtain higher transmit power, thus greatly improving the overall spectrum efficiency.

For ease of understanding of the embodiments of this application, an extremely high throughput (EHT) trigger-based (TB) physical layer protocol data unit (PPDU) format related to this application is described.

FIG. 2 is a schematic diagram of a format of an EHT TB PPDU. As shown in FIG. 2, the EHT TB PPDU may include the following fields:
legacy short training field (L-STF);
legacy long training field (L-LTF);
legacy signal field (L-SIG);
repeated legacy signal field (RL-SIG), which is a repetition of L-SIG; universal signal field (U-SIG);
extremely high throughput short training field (EHT-STF);
extremely high throughput long training field (EHT-LTF);
data field; and packet extension (PE) field.

For a TB PPDU, a preamble includes L-STF, L-LTF, L-SIG, RL-SIG, U-SIG, EHT-STF, and EHT-LTF.

The L-STF, L-LTF, L-SIG, RL-SIG, and U-SIG fields are called pre-EHT modulated fields (pre-EHT modulated fields).

EHT-STF and EHT-LTF are called EHT modulated fields (EHT modulated fields).

EHT-LTF may be used for channel estimation. Therefore, in the case of introducing PPDU transmission on a DRU, how to transmit the LTF to ensure channel estimation performance is an urgent problem to be solved.

The technical solution of this application is described in detail below through specific embodiments. The above related technologies, as optional solutions, may be combined with the technical solution of the embodiments of this application in any way, and all such combinations fall within the protection scope of the embodiments of this application.

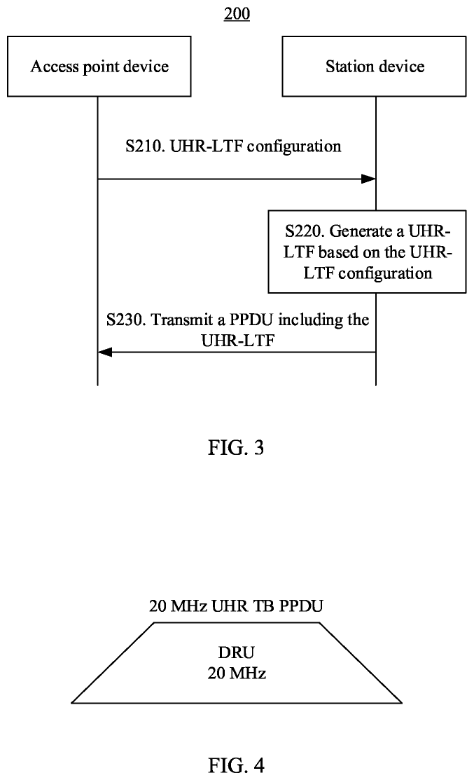

FIG. 3 is a schematic interaction diagram of a wireless communication method 200 according to an embodiment of this application. As shown in FIG. 3, the method 200 includes at least part of the following.

S210. An access point device indicates an ultra high reliability long training field UHR-LTF configuration to a station device.

Correspondingly, the station device receives the UHR-LTF configuration from the access point device.

S220. The station device generates a UHR-LTF based on the UHR-LTF configuration.

S230. The station device transmits a physical layer protocol data unit PPDU on a target resource unit.

Correspondingly, the access point device receives the PPDU on the target resource unit.

The station device in the embodiments of this application may be the station 120 in the communication system shown in FIG. 1, or called non-AP STA. For example, the station device may be but is not limited to various types of the station 120. The access point device in the embodiments of this application may be the access point 110 in the communication system shown in FIG. 1, or called AP STA. For example, the access point device may be but is not limited to various types of the access point 110.

Optionally, the PPDU may be a TB PPDU.

In some embodiments, the target resource unit includes a DRU and/or a contiguous resource unit.

In some embodiments, the target resource unit is a resource unit allocated by the access point device for transmitting the PPDU.

In the embodiments of this application, the contiguous resource unit may be an RU composed of a plurality of contiguous subcarriers or tones.

In the embodiments of this application, the contiguous resource unit is also referred to as regular resource unit (RRU). Certainly, the contiguous resource unit may alternatively be replaced with other names, which is not limited in this application.

In the embodiments of this application, an RU including K contiguous tones is called a K-tone RRU. For example, a 26-tone RRU is an RU including 26 contiguous tones. That is, the concept of the K-tone RRU is the same as the concept of the K-tone RU in the existing 802.11ax/802.11be standard.

In the embodiments of this application, the DRU may be an RU composed of a certain quantity of subcarriers that are extended or distributed over a certain bandwidth.

In the embodiments of this application, a DRU including K tones is called a K-tone DRU. For example, a 26-tone DRU is a DRU including 26 subcarriers. That is, the concept of the K-tone DRU is the same as the concept of the K-tone DRU in the 802.11bn standard.

In the embodiments of this application, the subcarrier and the tone may be used interchangeably.

In some embodiments, the target resource unit includes only the DRU, that is, the PPDU may be transmitted only on the DRU.

In some other embodiments, the target resource unit includes the DRU and the RRU, that is, the PPDU is transmitted on the DRU and RRU, which is called a hybrid mode of DRU and RRU.

In still some other embodiments, the target resource unit includes only the RRU, that is, the PPDU is transmitted only on the RRU.

It should be noted that in the embodiments of this application, the PPDU transmission on the DRU may mean that the data field of the PPDU is transmitted on the DRU, that is, the resource unit occupied by the data field includes the DRU. The PPDU transmission on the RRU may mean that the data field of the PPDU is transmitted on the RRU, that is, the resource unit occupied by the data field includes the RRU. The PPDU transmission on the DRU and RRU may mean that the data field of the PPDU is transmitted on the DRU and RRU, that is, the resource units occupied by the data field include the DRU and RRU.

It should be understood that the type of the RU for UHR-LTF transmission is not limited in this application. For example, the UHR-LTF may be transmitted on the DRU, on the RRU, or on the DRU and RRU.

It should be noted that in the embodiments of this application, the UHR-LTF may be the name of the LTF with the DRU introduced, which may alternatively be replaced with other names, which is not limited in this application.

In some embodiments, the PPDU includes a UHR-LTF, and the UHR-LTF is generated based on the UHR-LTF configuration.

In some embodiments, the UHR-LTF configuration includes but is not limited to at least one of the following:
a sequence configuration of the UHR-LTF;
a quantity of tones occupied by the UHR-LTF;
a number of symbols of the UHR-LTF;
a UHR-LTF type supported by the PPDU;
a cyclic shifts delay/diversity (CSD) configuration of the UHR-LTF; or
a guard interval (GI) supported by the PPDU.

For example, the station device may determine, based on the UHR-LTF configuration, the sequence used by the UHR-LTF in the PPDU, the quantity of tones occupied by the UHR-LTF, the number of symbols of the UHR-LTF, the UHR-LTF type, the CSD used by the UHR-LTF, the GI supported by the PPDU, and the like, thereby implementing transmission of the UHR-LTF when transmitting the data field on the DRU, so that the UHR-LTF matches the data field, ensuring the channel estimation performance.

It should be noted that in the embodiments of this application, part or all of the UHR-LTF configuration may be predefined or default. In this case, the access point device may not configure the corresponding configuration for the station device, and the station device may use the default configuration.

In some embodiments, the UHR-LTF uses part or all of a predefined LTF sequence, and the predefined LTF sequence may be an LTF sequence specified by the protocol, such as the LTF sequence defined in 802.11ax/be, including an EHT-LTF sequence, a high efficiency long training field (HE-LTF) sequence, a high throughput long training field (HT-LTF) sequence, and a very high throughput long training field (VHT-LTF) sequence.

In the embodiments of this application, the sequence used by the UHR-LTF is also referred to as a UHR-LTF sequence. In one embodiment, the sequence used by the UHR-LTF is composed of at least two of the following: 0, +1, and −1.

In some embodiments, if the sequence used by the UHR-LTF is predefined or default, the access point device may not configure the sequence used by the UHR-LTF for the station device, and the station device may transmit the UHR-LTF using the predefined sequence.

In some embodiments, for a UHR-LTF corresponding to a distributed bandwidth of the DRU in the PPDU, a sequence used by the UHR-LTF is related to a PPDU bandwidth.

Optionally, the UHR-LTF corresponding to the distributed bandwidth of the DRU may be understood as the UHR-LTF corresponding to the data field transmitted on the distributed bandwidth of the DRU.

For example, the station device may select a corresponding sequence to transmit the UHR-LTF according to the size of the PPDU bandwidth.

Optionally, the PPDU bandwidth and the UHR-LTF sequence may have a correspondence, and the station device may select the sequence used by the UHR-LTF based on the PPDU bandwidth configured by the access point device in combination with the correspondence.

In some embodiments, for a UHR-LTF corresponding to a distributed bandwidth of the DRU in the PPDU, a quantity of tones occupied by the UHR-LTF is the same as a quantity of tones occupied by a largest contiguous resource unit corresponding to a distributed bandwidth within the PPDU bandwidth.

In the embodiments of this application, the tone occupied by the UHR-LTF is also referred to as a UHR-LTF tone.

Examples are given for description with reference to FIGS. 4 to 7.

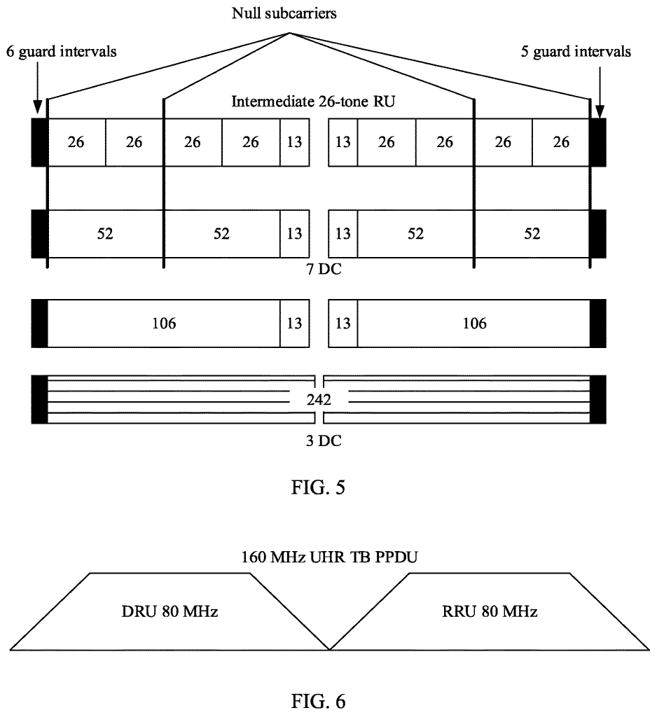

In the example of FIG. 4, the PPDU is transmitted only on the DRU, where the PPDU bandwidth is 20 MHz, the distributed bandwidth of the DRU is 20 MHz, and the DRU size is 26-tone. FIG. 5 shows the RU allocation under 20 MHz. As shown in FIG. 5, the largest RRU corresponding to the distributed bandwidth within the 20 MHz PPDU bandwidth includes 242 tones, so the quantity of tones occupied by the UHR-LTF is also 242.

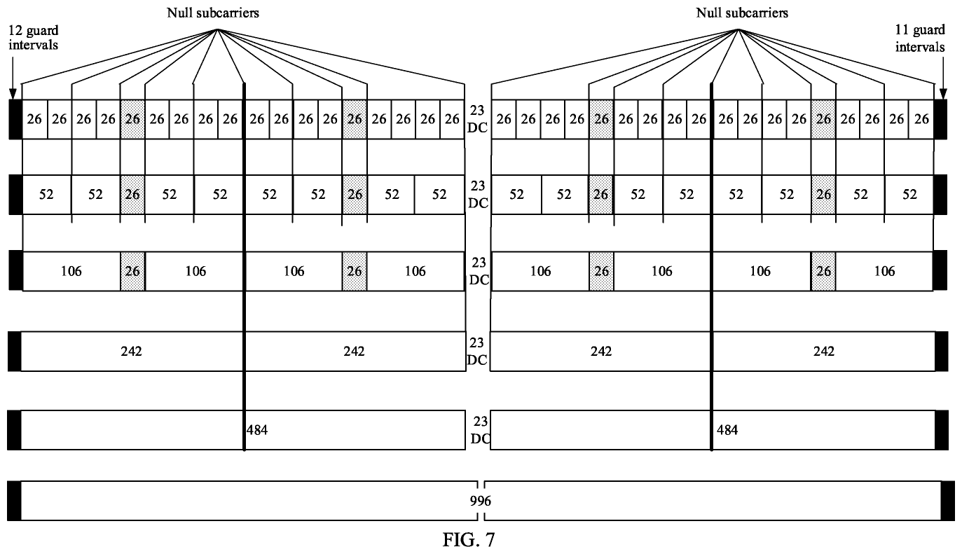

In the example of FIG. 6, the PPDU is transmitted on the DRU and RRU, where the PPDU bandwidth is 160 MHz, the RRU and the DRU each occupy 80 MHz, the DRU allocated by the access point device is 106-tone, and the RRU is 106-tone. FIG. 7 shows the RU allocation under 80 MHz. As shown in FIG. 7, the largest RRU corresponding to the distributed bandwidth under 80 MHz includes 996 tones, so the quantity of tones occupied by the UHR-LTF is also 996.

Optionally, the UHR-LTF sequence may be selected based on the quantity of tones occupied by the UHR-LTF. For example, a sequence occupying the same quantity of tones in a predefined LTF sequence (such as the LTF sequence defined in 802.11ax/be) is selected as the UHR-LTF sequence. For example, if the quantity of tones occupied by the UHR-LTF is 245, the sequence on 245 tones in the predefined LTF sequence is selected as the UHR-LTF sequence. For another example, if the quantity of tones occupied by the UHR-LTF is 242, the sequence on 242 tones in the predefined LTF sequence is selected as the UHR-LTF sequence. In some embodiments, in 802.11ax/be, taking a 20 MHz PPDU bandwidth as an example, the 1×EHT-LTF sequence transmitted on subcarriers [−122:122] is as follows:

$${EHTLTF}_{- 122 : 122} = \{ 0 , 0 , - 1 , 0 , 0 , 0 , + 1 , 0 , 0 , 0 , + 1 , 0 , 0 , 0 , - 1 , 0 , 0 , 0 , + 1 , 0 , 0 , 0 , - 1 , 0 , 0 , 0 , + 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , 0 , 0 , 0 , 0 , - 1 , 0 , 0 , 0 , + 1 , 0 , 0 , 0 , + 1 , 0 , 0 , 0 , + 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , + 1 , 0 , 0 , 0 , - 1 , 0 , 0 , 0 , - 1 , 0 , 0 , 0 , - 1 , 0 , 0 , 0 , - 1 , 0 , 0 , 0 , - 1 , 0 , 0 \}$$

In some embodiments, for the UHR-LTF corresponding to the distributed bandwidth of the DRU in the PPDU, if the quantity of tones occupied by the UHR-LTF is 245, all of the 1×EHT-LTF sequence, that is, values on 245 tones, may be selected as the UHR-LTF sequence.

$${UHRLTF}_{- 122 : 122} = \{ 0 , 0 , - 1 , 0 , 0 , 0 , + 1 , 0 , 0 , 0 , + 1 , 0 , 0 , 0 , - 1 , 0 , 0 , 0 , + 1 , 0 , 0 , 0 , - 1 , 0 , 0 , 0 , + 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , 0 , 0 , 0 , 0 , - 1 , 0 , 0 , 0 , + 1 , 0 , 0 , 0 , + 1 , 0 , 0 , 0 , + 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , + 1 , 0 , 0 , 0 , - 1 , 0 , 0 , 0 , - 1 , 0 , 0 , 0 , - 1 , 0 , 0 , 0 , - 1 , 0 , 0 , 0 , - 1 , 0 , 0 \}$$

In some other embodiments, for the UHR-LTF corresponding to the distributed bandwidth of the DRU in the PPDU, part of the 1×EHT-LTF sequence may be used. For example, the quantity of tones occupied by the UHR-LTF is the same as the quantity of tones occupied by the largest RRU corresponding to the distributed bandwidth within the PPDU bandwidth. If the largest RRU within 20 MHz occupies 242 tones, the sequence used by the UHR-LTF may have 242 values. For example, values on 242 tones out of 245 tones of the 1×EHT-LTF sequence may be taken to form the UHR-LTF sequence.

For example, the sequence used by the UHR-LTF may be as follows:

$${UHRLTF}_{- 121 : 120} = {EHTLTF}_{- 121 : 120} = \{ 0 , - 1 , 0 , 0 , 0 , + 1 , 0 , 0 , 0 , + 1 , 0 , 0 , 0 , - 1 , 0 , 0 , 0 , + 1 , 0 , 0 , 0 , - 1 , 0 , 0 , 0 , + 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , 0 , 0 , 0 , 0 , - 1 , 0 , 0 , 0 , + 1 , 0 , 0 , 0 , + 1 , 0 , 0 , 0 , + 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , + 1 , 0 , 0 , 0 , - 1 , 0 , 0 , 0 , - 1 , 0 , 0 , 0 , - 1 , 0 , 0 , 0 , - 1 , 0 , 0 , 0 , - 1 \}$$

For another example, the sequence used by the UHR-LTF may be as follows:

$${UHRLTF}_{- 120 : 121} = {EHTLTF}_{- 120 : 121} = \{ - 1 , 0 , 0 , 0 , + 1 , 0 , 0 , 0 , + 1 , 0 , 0 , 0 , - 1 , 0 , 0 , 0 , + 1 , 0 , 0 , 0 , - 1 , 0 , 0 , 0 , + 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , 0 , 0 , 0 , 0 , - 1 , 0 , 0 , 0 , + 1 , 0 , 0 , 0 , + 1 , 0 , 0 , 0 , + 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , + 1 , 0 , 0 , 0 , - 1 , 0 , 0 , 0 , - 1 , 0 , 0 , 0 , - 1 , 0 , 0 , 0 , - 1 , 0 , 0 , 0 , - 1 , 0 \}$$

It should be understood that the foregoing sequences used by the UHR-LTF are only examples, and another sequence with low peak to average power ratio (PAPR) may alternatively be used as the sequence of the UHR-LTF, which is not limited in this application.

In some embodiments, for different spatial stream quantities, an initial number of symbols of the UHR-LTF is the same as a predefined initial number of symbols. For example, the initial number of symbols of the UHR-LTF is the same as the initial number of symbols of the LTF sequence defined in 802.11ax/be, and specifically, for example, the same as the initial number of symbols of the EHT-LTF/IE-LTF/HT-LTF. For example, the maximum value of the initial number of symbols of the UHR-LTF may be 8. The UHR-LTF sequence uses the same initial number of symbols as the predefined LTF sequence, which allows for simple implementation and better compatibility with the prior art.

For example, the initial number of symbols (denoted as Initial N_{UHR-LTF}) of the UHR-LTF may be a function of the total spatial stream quantity Nₛₛ. Table 1 is an example of the Initial N_{UHR-LTF} required under different spatial stream quantities.

TABLE 1

| | Initial |
|---|---|
| Nₛₛ | N_{UHR-LTF} |
| 1 | 1 |
| 2 | 2 |
| 3-4 | 4 |
| 5-6 | 6 |
| 7-8 | 8 |

In some other embodiments, the initial number of symbols of the UHR-LTF includes the predefined initial number of symbols, and may further include an additional initial number of symbols, for example, including the initial number of symbols of the LTF sequence defined in 802.11ax/be and the additional initial number of symbols. Optionally, the maximum value of the initial number of symbols of the UHR-LTF may be 16 or other values, which is not limited in this application. The UHR-LTF supports the additional initial number of symbols, so that the PPDU may support more spatial stream quantities, thereby adapting to application scenarios such as large capacity, high rate, and a plurality of users.

Optionally, support for the additional initial number of symbols by the station device is optional, for example, determined by the capability of the station device, for example, determined by the maximum number of symbols of the LTF supported by the station device.

Optionally, the maximum value of the initial number of symbols of the UHR-LTF is 16 or other values, such as 10, 12, or 14, which is not limited in this application.

Optionally, the maximum value of the initial number of symbols of the UHR-LTF is selected from a set {2, 4, 8, 10, 12, 14, 16}. For example, 8, 10, 16, or the like is selected as the maximum value of the initial number of symbols of the UHR-LTF.

Table 2 is another example of the Initial N_{UHR-LTF} required under different spatial stream quantities.

TABLE 2

| | Initial |
|---|---|
| Nₛₛ | N_{UHR-LTF} |
| 1 | 1 |
| 2 | 2 |
| 3-4 | 4 |
| 5-6 | 6 |
| 7-8 | 8 |
| 9-10 | 10 |
| 11-12 | 12 |
| 13-14 | 14 |
| 15-16 | 16 |

It should be understood that the correspondence between the Initial N_{UHR-LTF} and the spatial stream quantity Nₛₛ in Table 2 is only an example. Alternatively, the maximum spatial stream quantity Nₛₛ and the maximum initial number of symbols may be other values, which is not limited in this application.

In some embodiments, a number of symbols (that is, the actual number of symbols or the number of symbols configured by the access point device) of the UHR-LTF is greater than or equal to the initial number of symbols of the UHR-LTF.

In some embodiments, the number of symbols of the UHR-LTF is greater than or equal to the maximum value of the initial number of symbols of the UHR-LTF on each DRU or multiple distributed tone resource unit (MDRU).

In some embodiments, the number of symbols of the UHR-LTF is indicated by a trigger frame, and the trigger frame is used to trigger transmission of the PPDU.

It should be noted that the number of symbols of the UHR-LTF may be indicated by any field of the trigger frame, for example, indicated by an existing field, a reserved field, or a new field, which is not limited in this application.

In some specific embodiments, the number of symbols of the UHR-LTF is indicated by a common info field (Common Info field) of the trigger frame, for example, indicated by an existing field, a reserved field, or a new field in the common info field.

In some embodiments, the PPDU supports at least the following UHR-LTF types: 1×UHR-LTF, 2×UHR-LTF, and 4×UHR-LTF.

Optionally, 1×UHR-LTF may include part or all of 1×EHT-LTF.

Optionally, 2×UHR-LTF may include part or all of 2×EHT-LTF.

Optionally, 4×UHR-LTF may include part or all of 4×EHT-LTF.

In some embodiments, the PPDU supports at least the following three GI types: 0.8 us, 1.6 us, and 3.2 us.

In some embodiments, the PPDU further supports at least one of the following GI types: 0.1 us, 0.2 us, 0.4 us, 6.4 us, 12.8 us, or 25.6 us. In the embodiments of this application, the PPDU is configured to support a plurality of GI types, so that the PPDU may match different UHR-LTF types, service types, or transmission configurations. For example, the PPDU is configured to support GI types of 0.1 us, 0.2 us, and 0.4 us, so that the PPDU may carry transmission of low-latency services. The PPDU is configured to support GI types of 6.4 us, 12.8 us, and 25.6 us, so that the PPDU may match longer UHR-LTF sequences.

In some embodiments, a combination of a UHR-LTF type and a guard interval type supported by the PPDU is indicated by a trigger frame, and the trigger frame is used to trigger transmission of the PPDU.

It should be noted that the combination of the UHR-LTF type and the guard interval type supported by the PPDU may be indicated by any field of the trigger frame, for example, indicated by an existing field, a reserved field, or a new field, which is not limited in this application.

In some embodiments, the combination of the UHR-LTF type and the guard interval type supported by the PPDU is indicated by a common info field of the trigger frame.

It should be noted that the combination of the UHR-LTF type and the guard interval type supported by the PPDU may be indicated by any field in the common info field, for example, indicated by an existing field, a reserved field, or a new field, which is not limited in this application.

In some embodiments, when a preamble of the PPDU is transmitted in a puncturing manner, a single large-size MDRU used for transmitting the preamble spans a non-punctured portion of a PPDU bandwidth.

The preamble of the PPDU may include the UHR-LTF, and transmission of the preamble of the PPDU in a puncturing manner may include transmission of the UHR-LTF in a puncturing manner. In this case, the single large-size MDRU used for transmitting the UHR-LTF spans the non-punctured portion of the PPDU bandwidth.

In some embodiments, the large-size MDRU is a combination of a plurality of large-size DRUs, and a quantity of tones occupied by the large-size DRU is greater than or equal to a preset value. Optionally, the preset value may be 242 tones or other values, which is not limited in this application.

Taking the preset value being 242 tones as an example, the large-size MDRU may include but is not limited to at least one of the following:
484+242-tone DRU, 996+484-tone DRU, 996+484+242-tone DRU, 2*996+484-tone DRU, 3*996-tone DRU, or 2*996+484-tone DRU.

In some embodiments, when the UHR-LTF is transmitted on the large-size MDRU, sequence values of the UHR-LTF on tones outside the large-size MDRU are set to 0.

That is, the sequence values on tones corresponding to the punctured portion outside the large-size MDRU occupied by the UHR-LTF are set to 0.

In some embodiments, the UHR-LTF is transmitted by a station device using a local CSD or a global CSD, which prevents unintended beamforming. Unintended beamforming may be caused by a plurality of station devices concurrently transmitting the same LTF sequence on the same tone set. For example, such superimposed LTF transmissions may constructively or destructively interfere at a receiving device, resulting in inaccurate LTF measurement results obtained by the receiving device. The global CSD being applied to the LTF sequence transmitted by each station device on each spatial stream may decouple the LTF transmissions from the plurality of station devices in the time domain. More specifically, the global CSD may stagger phases of the LTF transmissions across different station devices and different spatial streams, thereby preventing or reducing unintended beamforming at the receiving device.

For the global CSDs, STA 1 may apply m global CSDs to UHR-LTF sequences that are mapped to m spatial streams respectively, and STA 2 may apply n global CSDs to UHR-LTF sequences that are mapped to n spatial streams respectively, so that each of the different CSDs is applied to a UHR-LTF sequence that is mapped to each of the m+n spatial streams. Therefore, the global CSDs effectively decouple the plurality of STAs from the UHR-LTF transmissions in the time domain, thereby preventing unintended beamforming at the receiving device.

In some embodiments, the global CSD value may be obtained in the following manners.

Manner 1: Each STA may randomly generate its global CSD value. This manner of generating CSD is simple, and the processing complexity of the STA is low.

Manner 2: Each STA may select its global CSD from a predefined CSD table based on information (for example, association identifier (AID) value, RU index, RU allocation index, starting frequency tone offset associated with the DRU, or spatial stream information) allocated to the STA. This manner is conducive to reducing conflicts between the CSDs used by the plurality of STAs.

Manner 3: Each STA may receive an indication of its global CSD index or value in a trigger frame of the TB PPDU, where the trigger frame may indicate which STAs are allocated with distributed transmission information of the DRU used by the TB PPDU, or indicate specific distributed transmission information, such as distributed bandwidth information (for example, size and/or position of the distributed bandwidth) of the DRU or the quantity of tones occupied by the DRU. This manner is conducive to reducing conflicts between the CSDs used by the plurality of STAs.

For the local CSDs, if a plurality of STAs may transmit the same UHR-LTF sequence on different tone sets in the UHR-LTF of the TB PPDU, that is, separated in frequency, the local CSDs may be sufficient to overcome unintended beamforming in the UHR-LTF and data portion of the TB PPDU. In other words, STA 1 may apply its m CSDs “locally”, or does not need to consider the n CSDs applied by STA 2. Even if the m CSDs applied to the UHR-LTF and data portion that are mapped to m spatial streams are equal to the n CSDs (or a subset or superset thereof) applied to the UHR-LTF and data portion that are mapped to n spatial streams, unintended beamforming may be prevented in the UHR-LTF and data portion of the TB PPDU.

In some embodiments, the UHR-LTF is transmitted by the station device using a local CSD or a global CSD on each distributed bandwidth within a PPDU bandwidth. Since a plurality of DRUs transmitting the same LTF signal on the same distributed bandwidth results in unintended beamforming, in the embodiments of this application, the station device may transmit the UHR-LTF sequence using the local CSD or the global CSD on each distributed bandwidth within the PPDU bandwidth, thereby solving the unintended beamforming problem.

Optionally, the local CSD or the global CSD used by the station device on each distributed bandwidth within the PPDU bandwidth may be the same or different.

In some embodiments, the local CSD or the global CSD is allocated based on a first table or a first value set, where the first table is a correspondence table between total spatial stream quantities and cyclic shift values, the first value set includes a plurality of candidate cyclic shift values, the plurality of candidate cyclic shift values correspond to a plurality of total spatial stream quantities, and a maximum value of the total spatial stream quantity is 8.

That is, the station device may transmit the UHR-LTF sequence using the cyclic shift value in the first table or the first value set.

Optionally, in some embodiments, the total spatial stream quantity may be allocated by the access point device to the station device for transmitting the PPDU, and the station device may determine the cyclic shift value corresponding to each spatial stream based on the total spatial stream quantity in combination with the first table or the first value set, and further use the cyclic shift value when transmitting the UHR-LTF sequence.

Optionally, the first table may be a predefined table, such as the CSD table in 802.11ax/be, and the first value set may be a predefined value set, such as the CSD value set in 802.11ax/be.

Table 3 shows an example of the first table.

TABLE 3
T_{CS,UHR}(n) for UHR modulated fields in PPDU

| Total spatial | | | | | | | | |
|---|---|---|---|---|---|---|---|---|
| stream | | | | | | | | |
| quantity | Cyclic shift value (ns) for spatial stream n | | | | | | | |
| (N_{STS,total}) | 1 | 2 | 3 | 4 | 5 | 6 | 7 | 8 |
| 1 | 0 | — | — | — | — | — | — | — |
| 2 | 0 | −400 | — | — | — | — | — | — |
| 3 | 0 | −400 | −200 | — | — | — | — | — |
| 4 | 0 | −400 | −200 | −600 | — | — | — | — |
| 5 | 0 | −400 | −200 | −600 | −350 | — | — | — |
| 6 | 0 | −400 | −200 | −600 | −350 | −650 | −100 | — |
| 7 | 0 | −400 | −200 | −600 | −350 | −650 | −100 | — |
| 8 | 0 | −400 | −200 | −600 | −350 | −650 | −100 | −750 |

In some embodiments, the local CSD or the global CSD is allocated based on a second table or a second value set, where the second table is a correspondence table between total spatial stream quantities and cyclic shift values, the second value set includes a plurality of candidate cyclic shift values, the plurality of candidate cyclic shift values correspond to a plurality of total spatial stream quantities, and a maximum value of the total spatial stream quantity is greater than 8.

In some embodiments, the maximum value of the total spatial stream quantity is 10, 12, 14, 16, or the like, which is not limited in this application.

Table 4 shows an example of the second table, in which the maximum value of the total spatial stream quantity is 12.

TABLE 4
T_{CS,UHR}(n) for UHR modulated fields in PPDU

| Total | | | | | | | | | | | | |
|---|---|---|---|---|---|---|---|---|---|---|---|---|
| spatial | | | | | | | | | | | | |
| stream | | | | | | | | | | | | |
| quantity | Cyclic shift value (ns) for spatial stream n | | | | | | | | | | | |
| (N_{STS,total}) | 1 | 2 | 3 | 4 | 5 | 6 | 7 | 8 | 9 | 10 | 11 | 12 |
| 1 | 0 | — | — | — | — | — | — | — | — | — | — | — |
| 2 | 0 | −400 | — | — | — | — | — | — | — | — | — | — |
| 3 | 0 | −400 | −200 | — | — | — | — | — | — | — | — | — |
| 4 | 0 | −400 | −200 | −600 | — | — | — | — | — | — | — | — |
| 5 | 0 | −400 | −200 | −600 | −350 | — | — | — | — | — | — | — |
| 6 | 0 | −400 | −200 | −600 | −350 | −650 | −100 | — | — | — | — | — |
| 7 | 0 | −400 | −200 | −600 | −350 | −650 | −100 | — | — | — | — | — |
| 8 | 0 | −400 | −200 | −600 | −350 | −650 | −100 | −750 | — | — | — | — |
| 9 | 0 | −400 | −200 | −600 | −350 | −650 | −100 | −750 | −300 | — | — | — |
| 10 | 0 | −400 | −200 | −600 | −350 | −650 | −100 | −750 | −300 | −700 | — | — |
| 11 | 0 | −400 | −200 | −600 | −350 | −650 | −100 | −750 | −300 | −700 | −550 | — |
| 12 | 0 | −400 | −200 | −600 | −350 | −650 | −100 | −750 | −300 | −700 | −550 | −950 |

Table 5 shows another example of the second table, in which the maximum value of the total spatial stream quantity is 16.

TABLE 5
T_{CS,UHR}(n) for UHR modulated fields in PPDU

| Total | | | | | | | | |
|---|---|---|---|---|---|---|---|---|
| spatial | | | | | | | | |
| stream | | | | | | | | |
| quantity | Cyclic shift value (ns) for spatial stream n | | | | | | | |
| (N_{STS,total}) | 1 | 2 | 3 | 4 | 5 | 6 | 7 | 8 |
| 1 | 0 | — | — | — | — | — | — | — |
| 2 | 0 | −400 | — | — | — | — | — | — |
| 3 | 0 | −400 | −200 | — | — | — | — | — |
| 4 | 0 | −400 | −200 | −600 | — | — | — | — |
| 5 | 0 | −400 | −200 | −600 | −350 | — | — | — |
| 6 | 0 | −400 | −200 | −600 | −350 | −650 | −100 | — |
| 7 | 0 | −400 | −200 | −600 | −350 | −650 | −100 | — |
| 8 | 0 | −400 | −200 | −600 | −350 | −650 | −100 | −750 |
| 9 | 0 | −400 | −200 | −600 | −350 | −650 | −100 | −750 |
| 10 | 0 | −400 | −200 | −600 | −350 | −650 | −100 | −750 |
| 11 | 0 | −400 | −200 | −600 | −350 | −650 | −100 | −750 |
| 12 | 0 | −400 | −200 | −600 | −350 | −650 | −100 | −750 |
| 13 | 0 | −400 | −200 | −600 | −350 | −650 | −100 | −750 |
| 14 | 0 | −400 | −200 | −600 | −350 | −650 | −100 | −750 |
| 15 | 0 | −400 | −200 | −600 | −350 | −650 | −100 | −750 |
| 16 | 0 | −400 | −200 | −600 | −350 | −650 | −100 | −750 |
| Total | | | | | | | | |
| spatial | | | | | | | | |
| stream | | | | | | | | |
| quantity | Cyclic shift value (ns) for spatial stream n | | | | | | | |
| (N_{STS,total}) | 9 | 10 | 11 | 12 | 13 | 14 | 15 | 16 |
| 1 | — | — | — | — | — | — | — | — |
| 2 | — | — | — | — | — | — | — | — |
| 3 | — | — | — | — | — | — | — | — |
| 4 | — | — | — | — | — | — | — | — |
| 5 | — | — | — | — | — | — | — | — |
| 6 | — | — | — | — | — | — | — | — |
| 7 | — | — | — | — | — | — | — | — |
| 8 | — | — | — | — | — | — | — | — |
| 9 | −300 | — | — | — | — | — | — | — |
| 10 | −300 | −700 | — | — | — | — | — | — |
| 11 | −300 | −700 | −550 | — | — | — | — | — |
| 12 | −300 | −700 | −550 | −950 | — | — | — | — |
| 13 | −300 | −700 | −550 | −950 | −800 | — | — | — |
| 14 | −300 | −700 | −550 | −950 | −800 | −1000 | — | — |
| 15 | −300 | −700 | −550 | −950 | −800 | −1000 | −450 | — |
| 16 | −300 | −700 | −550 | −950 | −800 | −1000 | −450 | −1100 |

In conclusion, the access point device may indicate the UHR-LTF configuration for transmitting the PPDU on the DRU to the station device, so that the station device may fill the UHIR-LTF in the PPDU based on the UHIR-LTF configuration, implementing transmission of the UHIR-LTF to ensure the channel estimation performance during PPDU transmission on the DRU.

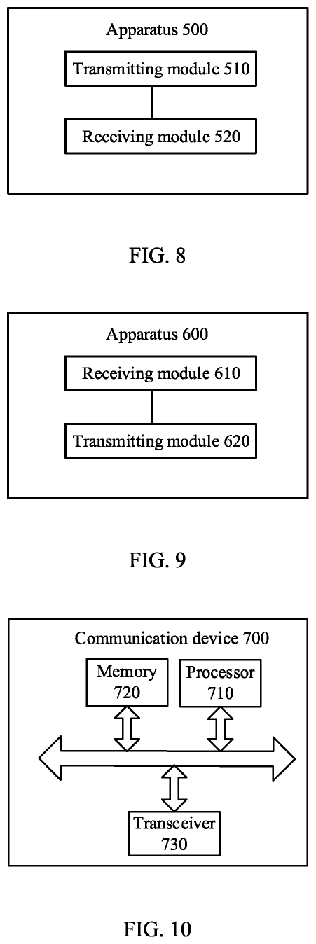

The method embodiments of this application are described in detail above with reference to FIGS. 3 to 7. The following describes the apparatus embodiments of this application in detail with reference to FIGS. 8 to 12. It should be understood that the apparatus embodiments correspond to the method embodiments, and similar descriptions may refer to the method embodiments.

FIG. 8 is a schematic block diagram of a wireless communication apparatus 500 according to an embodiment of this application. The wireless communication apparatus 500 may be an access point device or a component in an access point device, such as a chip, a circuit, or a module.

As shown in FIG. 8, the wireless communication apparatus 500 includes:
a transmitting module 510, configured to indicate an ultra high reliability long training field UHR-LTF configuration to a station device; and
a receiving module 520, configured to receive a physical layer protocol data unit PPDU on a target resource unit, where the PPDU includes a UHR-LTF, the UHR-LTF is generated based on the UHR-LTF configuration, and the target resource unit includes a distributed tone resource unit DRU and/or a contiguous resource unit.

In some embodiments, the UHR-LTF configuration includes at least one of the following:
a sequence configuration of the UHR-LTF;
a quantity of tones occupied by the UHR-LTF;
a number of symbols of the UHR-LTF;
a UHR-LTF type supported by the PPDU;
a cyclic shifts delay CSD configuration of the UHR-LTF; or
a guard interval supported by the PPDU.

In some embodiments, the UHR-LTF uses part or all of an extremely high throughput long training field EHT-LTF sequence.

In some embodiments, the sequence used by the UHR-LTF is composed of at least two of the following: 0, +1, and −1.

In some embodiments, for a UHR-LTF corresponding to a distributed bandwidth of the DRU in the PPDU, a sequence used by the UHR-LTF is related to a PPDU bandwidth.

In some embodiments, for a UHR-LTF corresponding to a distributed bandwidth of the DRU in the PPDU, a quantity of tones occupied by the UHR-LTF is the same as a quantity of tones occupied by a largest contiguous resource unit corresponding to a distributed bandwidth within the PPDU bandwidth.

In some embodiments, for a UHR-LTF corresponding to a distributed bandwidth of the DRU in the PPDU, for different spatial stream quantities, an initial number of symbols of the UHR-LTF is the same as an initial number of symbols of an EHT-LTF, or the initial number of symbols of the UHR-LTF includes the initial number of symbols of the EHT-LTF and an additional initial number of symbols.

In some embodiments, a number of symbols of the UHR-LTF is greater than or equal to a maximum value of an initial number of symbols of a UHR-LTF on each DRU or multiple distributed tone resource unit MDRU.

In some embodiments, a maximum value of the initial number of symbols of the UHR-LTF is 16, or the maximum value of the initial number of symbols of the UHR-LTF is selected from a set {2, 4, 8, 10, 12, 14, 16}.

In some embodiments, a number of symbols of the UHR-LTF is indicated by a trigger frame, and the trigger frame is used to trigger transmission of the PPDU.

In some embodiments, the number of symbols of the UHR-LTF is indicated by a common info field of the trigger frame.

In some embodiments, the PPDU supports at least the following UHR-LTF types: 1×UHR-LTF, 2×UHR-LTF, and 4×UHR-LTF.

In some embodiments, the PPDU supports at least the following three guard interval types: 0.8 us, 1.6 us, and 3.2 us.

In some embodiments, the PPDU further supports at least one of the following guard interval types: 0.1 us, 0.2 us, 0.4 us, 6.4 us, 12.8 us, or 25.6 us.

In some embodiments, a combination of a UHR-LTF type and a guard interval type supported by the PPDU is indicated by a trigger frame, and the trigger frame is used to trigger transmission of the PPDU.

In some embodiments, the combination of the UHR-LTF type and the guard interval type supported by the PPDU is indicated by a common info field of the trigger frame.

In some embodiments, when a preamble of the PPDU is transmitted in a puncturing manner, a single large-size MDRU used for transmitting the preamble spans a non-punctured portion of a PPDU bandwidth, where the large-size MDRU is a combination of a plurality of large-size DRUs, and a quantity of tones occupied by the large-size DRU is greater than or equal to a preset value.

In some embodiments, sequence values of the UHR-LTF on tones outside the large-size MDRU are set to 0.

In some embodiments, the UHR-LTF is transmitted by the station device using a local CSD or a global CSD.

In some embodiments, the UHR-LTF is transmitted by the station device using a local CSD or a global CSD on each distributed bandwidth within a PPDU bandwidth.

In some embodiments, the local CSD or the global CSD is allocated based on a first table or a first value set, where the first table is a correspondence table between total spatial stream quantities and cyclic shift values, the first value set includes a plurality of candidate cyclic shift values, the plurality of candidate cyclic shift values correspond to a plurality of total spatial stream quantities, and a maximum value of the total spatial stream quantity is 8.

In some embodiments, the local CSD or the global CSD is allocated based on a second table or a second value set, where the second table is a correspondence table between total spatial stream quantities and cyclic shift values, the second value set includes a plurality of candidate cyclic shift values, the plurality of candidate cyclic shift values correspond to a plurality of total spatial stream quantities, and a maximum value of the total spatial stream quantity is greater than 8.

In some embodiments, the maximum value of the total spatial stream quantity is 12 or 16.

Optionally, in some embodiments, the foregoing transmitting module or receiving module may be a communication interface, a transceiver, a communication chip, or an input/output interface of a system-on-chip. The foregoing processing module may be one or more processors.

It should be understood that the apparatus 500 according to the embodiments of this application corresponds to the access point device in the method embodiments of this application, and the foregoing and other operations and/or functions of the units in the apparatus 500 are for implementing the corresponding processes of the access point device in the embodiments shown in FIGS. 3 to 7, which are not described herein again for brevity.

FIG. 9 is a schematic block diagram of another wireless communication apparatus 600 according to an embodiment of this application. The wireless communication apparatus 600 may be a station device or a component in a station device, such as a chip, a circuit, or a module. The wireless communication apparatus 600 in FIG. 9 includes:
a receiving module 610, configured to receive an ultra high reliability long training field UHR-LTF configuration from an access point device; and
a transmitting module 620, configured to transmit a physical layer protocol data unit PPDU on a target resource unit, where the PPDU includes a UHR-LTF, the UHR-LTF is generated based on the UHR-LTF configuration, and the target resource unit includes a distributed tone resource unit DRU and/or a contiguous resource unit.

In some embodiments, the UHR-LTF configuration includes at least one of the following:
a sequence configuration of the UHR-LTF;
a quantity of tones occupied by the UHR-LTF;
a number of symbols of the UHR-LTF;
a UHR-LTF type supported by the PPDU;
a cyclic shifts delay CSD configuration of the UHR-LTF; or
a guard interval supported by the PPDU.

In some embodiments, the UHR-LTF uses part or all of an extremely high throughput long training field EHT-LTF sequence.

In some embodiments, the sequence used by the UHR-LTF is composed of at least two of the following: 0, +1, and −1.

In some embodiments, for a UHR-LTF corresponding to a distributed bandwidth of the DRU in the PPDU, a sequence used by the UHR-LTF is related to a PPDU bandwidth.

In some embodiments, for a UHR-LTF corresponding to a distributed bandwidth of the DRU in the PPDU, a quantity of tones occupied by the UHR-LTF is the same as a quantity of tones occupied by a largest contiguous resource unit corresponding to a distributed bandwidth within the PPDU bandwidth.

In some embodiments, for a UHR-LTF corresponding to a distributed bandwidth of the DRU in the PPDU, for different spatial stream quantities, an initial number of symbols of the UHR-LTF is the same as an initial number of symbols of an EHT-LTF, or the initial number of symbols of the UHR-LTF includes the initial number of symbols of the EHT-LTF and an additional initial number of symbols.

In some embodiments, a number of symbols of the UHR-LTF is greater than or equal to a maximum value of an initial number of symbols of a UHR-LTF on each DRU or multiple distributed tone resource unit MDRU.

In some embodiments, a maximum value of the initial number of symbols of the UHR-LTF is 16, or the maximum value of the initial number of symbols of the UHR-LTF is selected from a set {2, 4, 8, 10, 12, 14, 16}.

In some embodiments, a number of symbols of the UHR-LTF is indicated by a trigger frame, and the trigger frame is used to trigger transmission of the PPDU.

In some embodiments, the number of symbols of the UHR-LTF is indicated by a common info field of the trigger frame.

In some embodiments, the PPDU supports at least the following UHR-LTF types: 1×UHR-LTF, 2×UHR-LTF, and 4×UHR-LTF.

In some embodiments, the PPDU supports at least the following three guard interval types: 0.8 us, 1.6 us, and 3.2 us.

In some embodiments, the PPDU further supports at least one of the following guard interval types: 0.1 us, 0.2 us, 0.4 us, 6.4 us, 12.8 us, or 25.6 us.

In some embodiments, a combination of a UHR-LTF type and a guard interval type supported by the PPDU is indicated by a trigger frame, and the trigger frame is used to trigger transmission of the PPDU.

In some embodiments, the combination of the UHR-LTF type and the guard interval type supported by the PPDU is indicated by a common info field of the trigger frame.

In some embodiments, when a preamble of the PPDU is transmitted in a puncturing manner, a single large-size MDRU used for transmitting the preamble spans a non-punctured portion of a PPDU bandwidth, where the large-size MDRU is a combination of a plurality of large-size DRUs, and a quantity of tones occupied by the large-size DRU is greater than or equal to a preset value.

In some embodiments, sequence values of the UHR-LTF on tones outside the large-size MDRU are set to 0.

In some embodiments, the UHR-LTF is transmitted by the station device using a local CSD or a global CSD.

In some embodiments, the UHR-LTF is transmitted by the station device using a local CSD or a global CSD on each distributed bandwidth within a PPDU bandwidth.

In some embodiments, the local CSD or the global CSD is allocated based on a first table or a first value set, where the first table is a correspondence table between total spatial stream quantities and cyclic shift values, the first value set includes a plurality of candidate cyclic shift values, the plurality of candidate cyclic shift values correspond to a plurality of total spatial stream quantities, and a maximum value of the total spatial stream quantity is 8.

In some embodiments, the local CSD or the global CSD is allocated based on a second table or a second value set, where the second table is a correspondence table between total spatial stream quantities and cyclic shift values, the second value set includes a plurality of candidate cyclic shift values, the plurality of candidate cyclic shift values correspond to a plurality of total spatial stream quantities, and a maximum value of the total spatial stream quantity is greater than 8.

In some embodiments, the maximum value of the total spatial stream quantity is 12 or 16.

Optionally, in some embodiments, the foregoing transmitting module or receiving module may be a communication interface, a transceiver, a communication chip, or an input/output interface of a system-on-chip.

It should be understood that the apparatus 600 according to the embodiments of this application corresponds to the station device in the method embodiments of this application, and the foregoing and other operations and/or functions of the units in the apparatus 600 are for implementing the corresponding processes of the station device in the method embodiments shown in FIGS. 3 to 7, which are not described herein again for brevity.

FIG. 10 is a schematic structural diagram of a communication device 700 according to an embodiment of this application. The communication device 700 shown in FIG. 10 includes a processor 710. The processor 710 may invoke and run a computer program from a memory to implement the method in the embodiments of this application.

Optionally, as shown in FIG. 10, the communication device 700 may further include a memory 720. The processor 710 may invoke and run a computer program from the memory 720 to implement the method in the embodiments of this application. For example, when the communication device 700 is a station device, the processor 710 may invoke and run a computer program from the memory 720 to implement steps of the method embodiments executed by the station device, with the same technical effects achieved. When the communication device 700 is an access point device, the processor 710 may invoke and run a computer program from the memory 720 to implement steps of the method embodiments executed by the access point device, with the same technical effects achieved.

Optionally, the memory 720 may be a separate device independent of the processor 710, or integrated in the processor 710.

Optionally, as shown in FIG. 6, the communication device 700 may further include a transceiver 730. The processor 710 may control the transceiver 730 to communicate with other devices, and specifically, send information or data to other devices, or receive information or data sent by other devices.

Optionally, the transceiver 730 may include a transmitter and a receiver. The transceiver 730 may further include an antenna, and the quantity of antennas may be one or more.

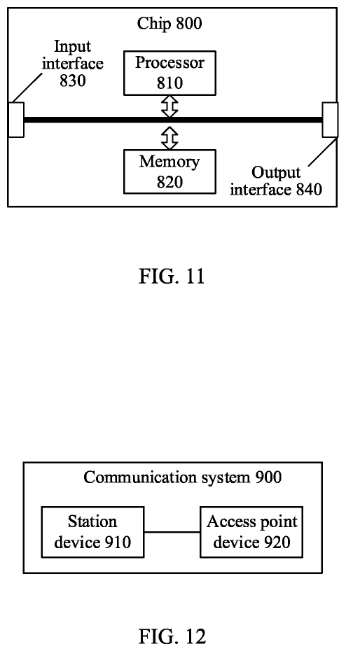

FIG. 11 is a schematic structural diagram of a chip according to an embodiment of this application. The chip 800 shown in FIG. 11 includes a processor 810. The processor 810 may invoke and run a computer program from a memory to implement the method in the embodiments of this application.

Optionally, as shown in FIG. 11, the chip 800 may further include a memory 820. The processor 810 may invoke and run a computer program from the memory 820 to implement the method in the embodiments of this application.

Optionally, the memory 820 may be a separate device independent of the processor 810, or integrated in the processor 810.

Optionally, the chip 800 may further include an input interface 830. The processor 810 may control the input interface 830 to communicate with other devices or chips, for example, obtain information or data sent by other devices or chips.

Optionally, the chip 800 may further include an output interface 840. The processor 810 may control the output interface 840 to communicate with other devices or chips, for example, output information or data to other devices or chips.

Optionally, the chip may be applied to the access point device in the embodiments of this application, and the chip may implement the corresponding processes implemented by the access point device in the methods of the embodiments of this application, which are not described herein again for brevity.

Optionally, the chip may be applied to the station device in the embodiments of this application, and the chip may implement the corresponding processes implemented by the station device in the methods of the embodiments of this application, which are not described herein again for brevity.

It should be understood that the chip mentioned in the embodiments of this application may also be referred to as a system-level chip, a system chip, a chip system, a system-on-chip, or the like.

FIG. 12 is a schematic block diagram of a communication system 900 according to an embodiment of this application. As shown in FIG. 12, the communication system 900 includes a station device 910 and an access point device 920.

The station device 910 may be used to implement the corresponding functions implemented by the station device in the foregoing method, and the access point device 920 may be used to implement the corresponding functions implemented by the access point device in the foregoing method, which are not described herein again for brevity.

It should be understood that the processor in the embodiments of this application may be an integrated circuit chip with a signal processing capability. During implementation, the steps of the foregoing method embodiments may be implemented by hardware integrated logic circuits in the processor or instructions in the form of software. The processor may be a general-purpose processor, a digital signal processor (DSP), an application specific integrated circuit (ASIC), a field programmable gate array (FPGA) or another programmable logic device, a discrete gate or transistor logic device, or a discrete hardware component. The processor may implement or execute the methods, steps, and logical block diagrams disclosed in the embodiments of this application. The general-purpose processor may be a microprocessor or any regular processor. The steps of the methods disclosed with reference to the embodiments of the application may be directly implemented by a hardware decoding processor, or may be implemented by a combination of hardware and a software module in a decoding processor. The software module may be located in a storage medium mature in the art, such as a random access memory, a flash memory, a read-only memory, a programmable read-only memory or electrically erasable programmable memory, or a register. The storage medium is located in the memory, and the processor fetches information in the memory, and completes the steps of the foregoing method in combination with its hardware.

It can be understood that the memory in this embodiment of this application may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. By way of example but not restrictive description, many forms of RAMs may be used, for example, a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). It should be noted that the memory in the system and method described in this specification is intended to include but is not limited to these and any other suitable types of memories.

It should be understood that the foregoing memories are examples but not restrictive description. For example, the memory in the embodiments of this application may alternatively be a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), or a direct rambus random access memory (DRRAM). That is, the memory in the embodiments of this application is intended to include but is not limited to these and any other suitable types of memories.

An embodiment of this application further provides a readable storage medium. The readable storage medium stores a computer program, and when the computer program is executed by a processor, the processes of the foregoing method embodiments are implemented.

Optionally, the readable storage medium may be applied to the access point device in the embodiments of this application, and the computer program causes the processor to execute the corresponding processes implemented by the access point device in the method embodiments of this application, which are not described herein again to avoid repetition.

Optionally, the readable storage medium may be applied to the station device in the embodiments of this application, and the computer program causes the processor to execute the corresponding processes implemented by the station device in the method embodiments of this application, which are not described herein again to avoid repetition.

An embodiment of this application further provides a computer program product, including a computer program. When the computer program is executed by a processor, the processes of the foregoing method embodiments are implemented.

Optionally, the computer program product may be applied to the access point device in the embodiments of this application, and the computer program causes the processor to execute the corresponding processes implemented by the access point device in the method embodiments of this application, which are not described herein again to avoid repetition.

Optionally, the computer program product may be applied to the station device in the embodiments of this application, and the computer program causes the processor to execute the corresponding processes implemented by the station device in the method embodiments of this application, which are not described herein again to avoid repetition.

An embodiment of this application further provides a computer program. When the computer program is executed by a processor, the processes of the foregoing method embodiments are implemented.

Optionally, the computer program may be applied to the access point device in the embodiments of this application, and the computer program causes the processor to execute the corresponding processes implemented by the access point device in the method embodiments of this application, which are not described herein again to avoid repetition.

Optionally, the computer program may be applied to the station device in the embodiments of this application, and the computer program causes the processor to execute the corresponding processes implemented by the station device in the method embodiments of this application, which are not described herein again to avoid repetition.

Persons of ordinary skill in the art may realize that the units and algorithm steps in the examples described with reference to the embodiments disclosed in this specification may be implemented by using electronic hardware or a combination of computer software and electronic hardware. Whether the functions are performed by hardware or software depends on particular applications and design constraints of the technical solutions. Persons skilled in the art may use different methods to implement the described functions for each particular application, but it should not be considered that the implementation goes beyond the scope of this application.

Persons skilled in the art may clearly understand that, for the purpose of convenient and brief description, for a detailed working process of the foregoing system, apparatus, and unit, reference may be made to a corresponding process in the foregoing method embodiments, and details are not described herein again.

In several embodiments provided in this application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network elements. Some or all of these units may be selected based on actual needs to achieve the objectives of the solutions of the embodiments.

In addition, the functional units in the embodiments of this application may be integrated into one processing unit, or each of the units may exist alone physically, or two or more units may be integrated into one unit.

If the functions are implemented in a form of a software functional unit and are sold or used as a separate product, the functions may be stored in a computer-readable storage medium. Based on such understanding, the technical solutions of this application essentially, or the part thereof that contributes to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the method described in the embodiments of this application. The foregoing storage medium includes: any medium that may store program code, such as a USB flash drive, a removable hard disk, a read-only memory (ROM), a random access memory (RAM), a magnetic disk, or an optical disc.

The foregoing descriptions are only specific implementations of this application, but are not intended to limit the protection scope of this application. Any variation or replacement apparent to persons skilled in the art within the technical scope disclosed in this application shall fall within the protection scope of this application. Therefore, the protection scope of this application shall be subject to the protection scope of the claims.

What is claimed is:

1. A wireless communication method, comprising:
indicating, by an access point device, an ultra high reliability long training field (UHR-LTF) configuration to a station device; and
receiving, by the access point device, a physical layer protocol data unit (PPDU) on a target resource unit, wherein the PPDU comprises a UHR-LTF, the UHR-LTF is generated based on the UHR-LTF configuration, and the target resource unit comprises a distributed tone resource unit DRU and/or a contiguous resource unit.

2. The method according to claim 1, wherein the UHR-LTF configuration comprises at least one of the following:
a sequence configuration of the UHR-LTF;
a quantity of tones occupied by the UHR-LTF;
a number of symbols of the UHR-LTF;
a UHR-LTF type supported by the PPDU;
a cyclic shifts delay (CSD) configuration of the UHR-LTF; or
a guard interval supported by the PPDU.

3. The method according to claim 1, wherein the UHR-LTF uses part or all of an extremely high throughput long training field (EHT-LTF) sequence, and the sequence used by the UHR-LTF is composed of at least two of the following: 0, +1, or −1.

4. The method according to claim 1, wherein a number of symbols of the UHR-LTF is indicated by a trigger frame, and the trigger frame is used to trigger transmission of the PPDU.

5. The method according to claim 4, wherein the number of symbols of the UHR-LTF is indicated by a common info field of the trigger frame.

6. The method according to claim 1, wherein the PPDU supports at least the following UHR-LTF types: 1×UHR-LTF, 2×UHR-LTF, and 4×UHR-LTF.

7. The method according to claim 1, wherein the PPDU supports at least the following three guard interval types: 0.8 us, 1.6 us, and 3.2 us.

8. The method according to claim 1, wherein a combination of a UHR-LTF type and a guard interval type supported by the PPDU is indicated by a trigger frame, and the trigger frame is used to trigger transmission of the PPDU.

9. The method according to claim 8, wherein the combination of the UHR-LTF type and the guard interval type supported by the PPDU is indicated by a common info field of the trigger frame.

10. A wireless communication method, comprising:
receiving, by a station device, an ultra high reliability long training field UHR-LTF configuration from an access point device; and
transmitting, by the station device, a physical layer protocol data unit PPDU on a target resource unit, wherein the PPDU comprises a UHR-LTF, the UHR-LTF is generated based on the UHR-LTF configuration, and the target resource unit comprises a distributed tone resource unit DRU and/or a contiguous resource unit.

11. The method according to claim 10, wherein the UHR-LTF configuration comprises at least one of the following:
a sequence configuration of the UHR-LTF;
a quantity of tones occupied by the UHR-LTF;
a number of symbols of the UHR-LTF;
a UHR-LTF type supported by the PPDU;
a cyclic shifts delay (CSD) configuration of the UHR-LTF; or
a guard interval supported by the PPDU.

12. The method according to claim 10, wherein the UHR-LTF uses part or all of an extremely high throughput long training field EHT-LTF sequence, and the sequence used by the UHR-LTF is composed of at least two of the following: 0, +1, or −1.

13. The method according to claim 10, wherein a number of symbols of the UHR-LTF is indicated by a trigger frame, and the trigger frame is used to trigger transmission of the PPDU.

14. The method according to claim 13, wherein the number of symbols of the UHR-LTF is indicated by a common info field of the trigger frame.

15. The method according to claim 10, wherein the PPDU supports at least the following UHR-LTF types: 1×UHR-LTF, 2×UHR-LTF, and 4×UHR-LTF.

16. The method according to claim 10, wherein the PPDU supports at least the following three guard interval types: 0.8 us, 1.6 us, and 3.2 us.

17. The method according to claim 10, wherein a combination of a UHR-LTF type and a guard interval type supported by the PPDU is indicated by a trigger frame, and the trigger frame is used to trigger transmission of the PPDU.

18. The method according to claim 17, wherein the combination of the UHR-LTF type and the guard interval type supported by the PPDU is indicated by a common info field of the trigger frame.

19. A non-transitory readable storage medium, configured to store a computer program, wherein the computer program causes a computer to execute the method according to claim 1.

20. A non-transitory readable storage medium, configured to store a computer program, wherein the computer program causes a computer to execute the method according to claim 10.
